(19) United States
(12) Patent Application Publication
(10) Pub. No.: US 2019/0210570 A1
(43) Pub. Date: Jul. 11, 2019

(54) SENSOR CLEANING AND COOLING

(71) Applicant: Ford Global Technologies, LLC, Dearborn, MI (US)

(72) Inventor: David Schmidt, Dearborn, MI (US)

(73) Assignee: Ford Global Technologies, LLC, Dearborn, MI (US)

(21) Appl. No.: 15/864,786

(22) Filed: Jan. 8, 2018

(51) Int. Cl. B60S 1/56; G01N 21/94; G01N 21/15; B08B 3/02; B08B 5/02; B60S 1/48; B60S 1/54

(52) U.S. Cl. CPC B60S 1/56; G01N 21/94; G01N 21/15; G01N 21/47; B08B 5/02; B60S 1/481; B60S 1/54; B08B 3/02

(57) ABSTRACT

A system includes a computer including a processor and a memory, the memory storing instructions executable by the processor to determine an amount of occluding material on a vehicle sensor, determine a temperature of the vehicle sensor, and actuate a liquid pump arranged to pump liquid to the vehicle sensor and an air pump arranged to pump air to the vehicle sensor based on the amount of occluding material and the temperature.

### BACKGROUND

Vehicles, such as passenger cars, typically include sensors to collect data about a surrounding environment. The sensors can be placed on or in various parts of the vehicle, e.g., a vehicle roof, a vehicle hood, a rear vehicle door, etc. The sensors, e.g., sensor lens covers, may become dirty during operation of the vehicle. Furthermore, the sensors may increase in temperature based on current environmental conditions. During vehicle operation, sensor data and/or environmental conditions around a vehicle can be changing, and such changes can affect sensor operation. It is a problem to process the various factors and to maintain sensors in a usable condition.

### BRIEF DESCRIPTION OF THE DRAWINGS

FIG. 1 is a block diagram of an example system for operating a sensor in a vehicle.

FIG. 2 is a view of an example vehicle with a sensor.

FIG. 3 is a plan view of an example sensor in a sensor housing.

FIG. 4 is a side view of the example sensor and a diverter valve.

FIG. 5 is a side view of the example sensor with the diverter valve actuated in a first position.

FIG. 6 is a side view of the example sensor with the diverter valve actuated in a second position.

FIG. 7 is a side view of the example sensor with the diverter valve opened.

FIG. 8 illustrates an example process for operating the sensor.

### DETAILED DESCRIPTION

A system includes a computer including a processor and a memory, the memory storing instructions executable by the processor to determine an amount of occluding material on a vehicle sensor, determine a temperature of the vehicle sensor, and actuate a liquid pump arranged to pump liquid to the vehicle sensor and an air pump arranged to pump air to the vehicle sensor based on the amount of occluding material and the temperature.

The instructions can further include instructions to pump liquid through a liquid tube extending around the vehicle sensor.

The instructions can further include instructions to actuate a diverter valve to pump liquid and air through an opening in a sensor housing onto the vehicle sensor. The instructions can further include instructions to actuate the diverter valve when the amount of occluding material exceeds an occluding material threshold.

The instructions can further include instructions to deactivate the sensor when the temperature exceeds a temperature threshold.

The instructions can further include instructions to actuate the liquid pump to a specified liquid pump duty cycle based on the amount of occluding material and the temperature.

The instructions can further include instructions to actuate the air pump to a specified air pump duty cycle based on the amount of occluding material and the temperature.

The instructions can further include instructions to, when the temperature is above a temperature threshold and the amount of occluding material is above an occluding material threshold, actuate the liquid pump and the air pump to cool the vehicle sensor. The instructions can further include instructions to determine a second temperature of the vehicle sensor and, when the second temperature is below the temperature threshold, actuate a diverter valve to pump liquid and air through an opening in a sensor housing onto the vehicle sensor.

A system includes a sensor housing including a fluid opening, a vehicle sensor disposed the sensor housing, a liquid pump disposed in the sensor housing, an air pump disposed in the sensor housing, a liquid tube connected to the liquid pump extending around the vehicle sensor, an air tube connected to the air pump and the fluid opening, means for determining an amount of occluding material on the vehicle sensor, means for determining a temperature of the vehicle sensor, and means for actuating the liquid pump and the air pump based on the amount of occluding material and the temperature.

The system can further include means for actuating a diverter valve to pump liquid and air through the fluid opening onto the vehicle sensor.

The system can further include means for deactivating the sensor when the temperature exceeds a temperature threshold.

The system can further include means for actuating the liquid pump and the air pump to cool the vehicle sensor when the temperature is above a temperature threshold and the amount of occluding material is above an occluding material threshold.

The system can further include means for determining a second temperature of the vehicle sensor and means for actuating a diverter valve to pump liquid and air through an opening in a sensor housing onto the vehicle sensor when the second temperature is below a temperature threshold.

A method includes determining an amount of occluding material on a vehicle sensor, determining a temperature of the vehicle sensor, and actuating a liquid pump to pump liquid to the vehicle sensor and an air pump to pump air to the vehicle sensor based on the amount of occluding material and the temperature.

The method can further include pumping liquid through a liquid tube extending around the vehicle sensor.

The method can further include actuating a diverter valve to pump liquid and air through an opening in a sensor housing onto the vehicle sensor. The method can further include actuating the diverter valve when the amount of occluding material exceeds an occluding material threshold.

The method can further include deactivating the sensor when the temperature exceeds a temperature threshold.

The method can further include, when the temperature is above a temperature threshold and the amount of occluding material is above an occluding material threshold, actuating the liquid pump and the air pump to cool the vehicle sensor.

To cool and clean a sensor, a computer can selectively actuate a liquid pump, an air pump, and a diverter valve to clean and/or cool the sensor based on the temperature of the sensor and the amount of occluding material on the sensor. When the computer determines to cool the sensor and not to clean the sensor, the computer can actuate the diverter valve to direct liquid into a cooling tube to cool the sensor with convection cooling. When the computer determines to clean the sensor but not to cool the sensor, the computer can actuate the diverter valve to direct the liquid into a mixing tube to mix with air and spray onto a surface of the sensor to clean the sensor. When the computer determines to clean and cool the sensor, the computer can actuate the diverter valve to direct the liquid to both the cooling tube and the mixing tube to cool and clean the sensor. The computer can, based on the temperature of the sensor and the amount of occluding material on the sensor, prioritize one of cleaning and cooling the sensor and actuate the diverter valve, the air pump, and the liquid pump to direct the liquid accordingly. Furthermore, as the sensor cools and is cleaned, the computer can actuate the diverter valve, the air pump, and the liquid pump based on a current amount of occluding material and a current temperature of the sensor.

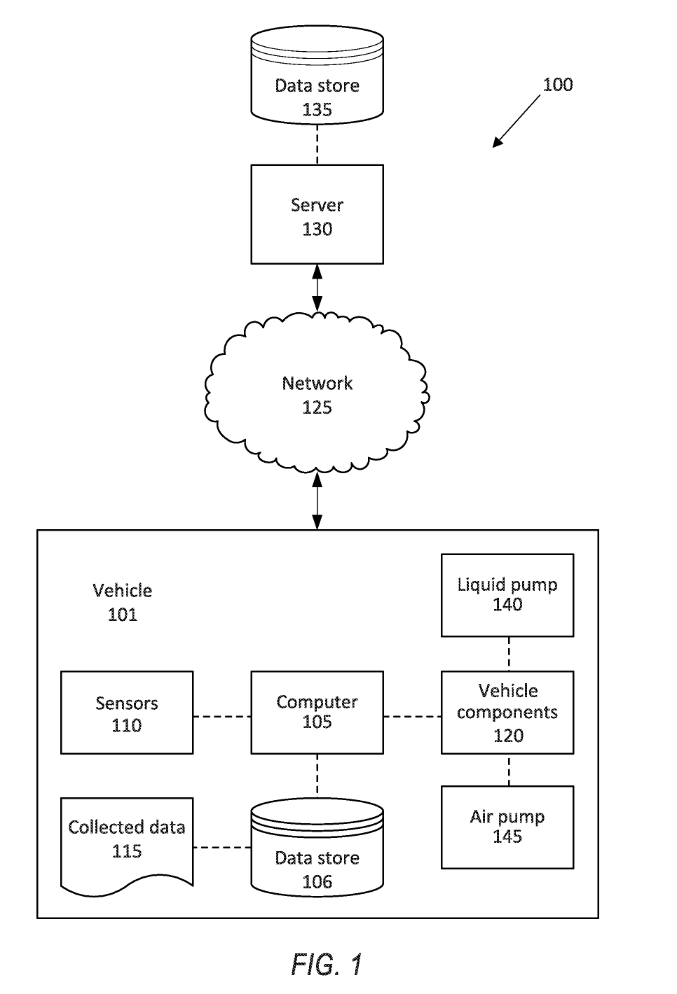

FIG. 1 illustrates an example system 100 for operating a sensor 110 in a vehicle 101. A computer 105 in the vehicle 101 is programmed to receive collected data 115 from one or more sensors 110. For example, vehicle 101 data 115 may include a location of the vehicle 101, data about an environment around a vehicle, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data 115 can include measurements of vehicle 101 systems and components, e.g., a vehicle 101 velocity, a vehicle 101 trajectory, etc.

The computer 105 is generally programmed for communications on a vehicle 101 network, e.g., including a conventional vehicle 101 communications bus. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, sensors, etc., including sensors 110. Alternatively or additionally, in cases where the computer 105 actually comprises multiple devices, the vehicle network may be used for communications between devices represented as the computer 105 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The data store 106 can be of any type, e.g., hard disk drives, solid state drives, servers, or any volatile or non-volatile media. The data store 106 can store the collected data 115 sent from the sensors 110.

Sensors 110 can include a variety of devices. For example, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc., i.e., sensors 110 to provide data 115 for evaluating a position of a component, evaluating a slope of a roadway, etc. The sensors 110 could, without limitation, also include short range radar, long range radar, LIDAR, and/or ultrasonic transducers.

Collected data 115 can include a variety of data collected in a vehicle 101. Examples of collected data 115 are provided above, and moreover, data 115 are generally collected using one or more sensors 110, and may additionally include data calculated therefrom in the computer 105, and/or at the server 130. In general, collected data 115 may include any data that may be gathered by the sensors 110 and/or computed from such data.

The vehicle 101 can include a plurality of vehicle components 120. In this context, each vehicle component 120 includes one or more hardware components adapted to perform a mechanical function or operation—such as moving the vehicle 101, slowing or stopping the vehicle 101, steering the vehicle 101, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like.

When the computer 105 operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computer 105. A semi-autonomous mode is one in which at least one of vehicle 101 propulsion (typically via a powertrain including an electric motor and/or internal combustion engine), braking, and steering are controlled at least partly by the computer 105 as opposed to a human operator. In a non-autonomous mode, i.e., a manual mode, the vehicle 101 propulsion, braking, and steering are controlled by the human operator.

The system 100 can further include a wide-area network 125 connected to a server 130 and a data store 135. The computer 105 can further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The vehicle 101 includes a liquid pump 140. The liquid pump 140 can move liquid to the sensors 110. The computer 105 can actuate the liquid pump 140 to cool and clean the sensors 110, as described below. For example, the computer 105 can actuate the liquid pump 140 to move the liquid around the sensors 110, cooling the sensors 110 with liquid convection cooling. The liquid pump 140 can pump, e.g., water, a cleaning liquid, a coolant, etc., to cool and clean the sensors 110.

The vehicle 101 includes an air pump 145. The air pump 145 can move air to the sensors 110. The computer 105 can actuate the air pump 145 to cool and clean the sensors 110, as described below. For example, the computer 105 can actuate the air pump 145 to move air across a surface of the sensors 110, cooling the sensors 110 with gas convection cooling. As described below, the computer 105 can actuate both the liquid pump 140 and the air pump 145 to cool and clean the sensors 110.

The computer 105 can actuate the liquid pump 140 and the air pump 145 to specified respective duty cycles. As used herein, a “duty cycle” is value between and including 0 and 1, representing a portion of a maximum operation of the liquid pump 140 and the air pump 145. When the duty cycle is 0, the liquid pump 140 or the air pump 145 is deactivated. When the duty cycle is 1, the liquid pump 140 or the air pump 145 operates at a respective predetermined maximum capacity, e.g., the liquid pump 140 moves as much liquid as allowed by the predetermined maximum capacity, the air pump 145 moves as much air as allowed by the predetermined maximum capacity, etc. The predetermined maximum capacity can be determined by, e.g., empirical tests, ratings from a manufacturer, material strength, etc., and can be stored in the data store 106 and/or the server 130. When the duty cycle is a value between 0 and 1, the liquid pump 140 or the air pump 145 operates at the proportion of the predetermined maximum capacity specified by the duty cycle, e.g., if the duty cycle is 30%, the liquid pump 140 or the air pump 145 operates at 30% of the predetermined maximum capacity.

The computer 105 can determine the duty cycle for the liquid pump 140 (i.e., the liquid pump 140 duty cycle) and the duty cycle for the air pump (i.e., the air pump 145 duty cycle) based on a temperature of the sensor 110 and an amount of occluding material on the sensor 110, as described below. As used herein, “occluding material” is material that can reduce the data and/or the quality of data collected by the sensors 110 when present on the sensors 110, e.g., dirt, dust, debris, mud, fog, dew, sand, frost, ice, grime, precipitation, moisture, etc.

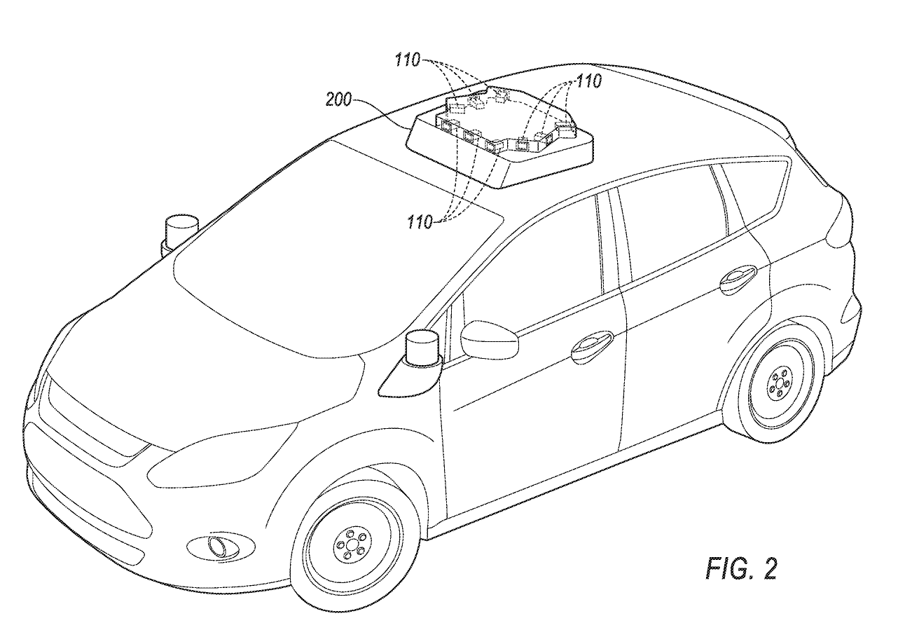

FIG. 2 illustrates an example vehicle 101. The vehicle 101 can be, e.g., an automobile, including a sedan, a pick-up truck, a sport-utility vehicle, etc. The vehicle 101 can be an autonomous vehicle 101. For example, the vehicle 101 can have a computer 105 that may control the operations of the vehicle 10 in an autonomous mode, a semi-autonomous mode, or a non-autonomous mode.

The vehicle 101 includes a sensor housing 200. The sensor housing 200 is fixed to the vehicle 101, e.g., on a vehicle 101 roof. The sensor housing 200 is a support structure or the like that can house a plurality of sensors 110, e.g., one or more cameras and one or more lidar sensors. The sensor housing 200 can secure the sensors 110 in a fixed orientation to collect data 115 in a specific direction relative to the vehicle 101. The sensors 110 can collect occluding material, reducing the amount of data 115 and/or the precision of the data 115 collected by the sensors 110.

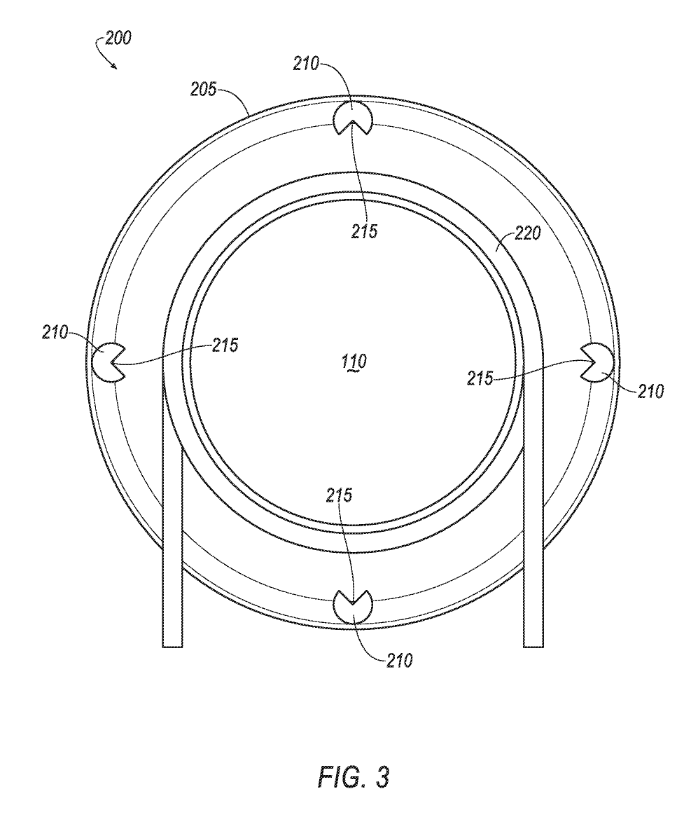

FIG. 3 illustrates an example sensor 110 in the sensor housing 200. The sensor housing 200 includes a sensor manifold 205. The sensor manifold 205 supports the sensor 110. The sensor manifold 205 can be, e.g., a circular indentation in the sensor housing 200 into which the sensor 110 is placed. The sensor manifold 205 can, as described below, allow air and liquid to move to the sensor 110.

The sensor manifold 205 can include a nozzle 210. The nozzle 210 sprays air and/or liquid onto the sensor 110. The nozzle 210 includes an opening 215 that allows a fluid (e.g., air, a cleaning liquid, etc.) to move through the nozzle 210 and onto the sensor 110. The nozzle 210 can be connected to the liquid pump 140 and the air pump 145, as described below. The sensor manifold 205 can include a plurality of nozzles 210, e.g., four nozzles 210 as shown in FIG. 3, or a different number of nozzles 210. The nozzles 210 can be directed to spray the air and/or the liquid vertically along a surface of the sensor 110.

The sensor manifold 205 can include a liquid tube 220. The liquid tube 220 is connected to the liquid pump 140. The liquid tube 220 allows the liquid pump 140 to pump the liquid toward and away from the sensor 110. The liquid tube 220 can extend around the sensor 110, and the liquid can absorb heat from the sensor 110 as the liquid moves in the liquid tube 220. For example, as shown in FIG. 3, the liquid tube 220 can wrap around the sensor 110 to provide convection cooling as the liquid moves in the liquid tube 220.

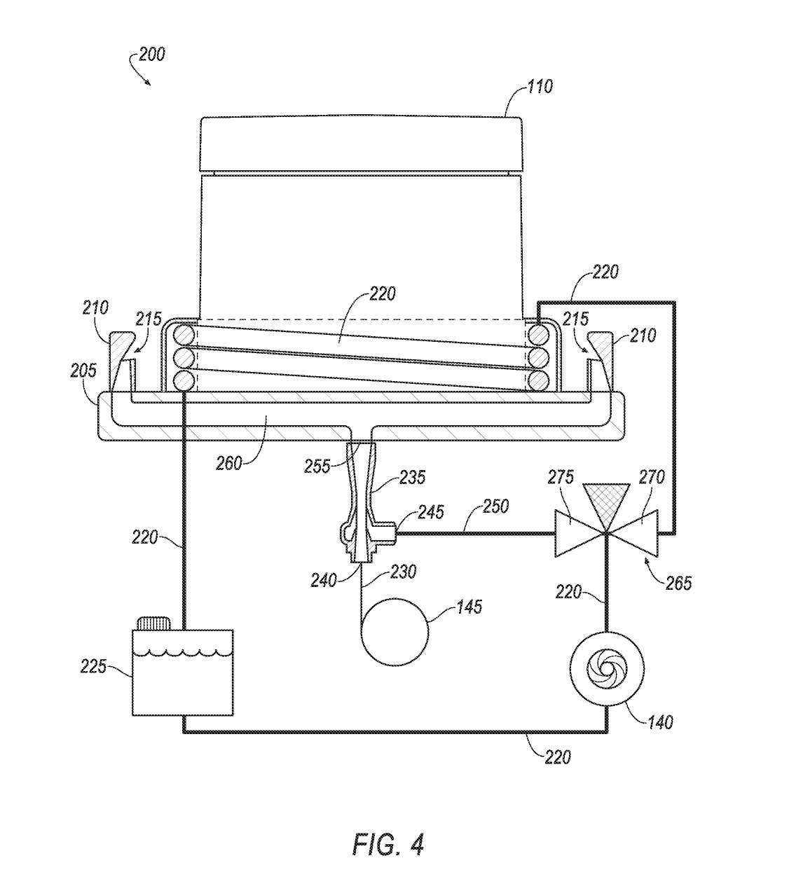

FIG. 4 shows a cross-sectional view of the sensor housing 200. As in FIG. 3, the vehicle 101 includes the sensor 110, the sensor manifold 205, the nozzles 210 (and the respective openings 215), the liquid tube 220, the liquid pump 140, and the air pump 145. FIG. 4 shows the sensor 110 installed in the sensor housing 200 when the computer 105 determines not to clean or cool the sensor 110.

The vehicle 101 includes a liquid reservoir 225. The liquid reservoir 225 stores the cleaning liquid. The liquid reservoir 225 can be connected to the liquid pump 140 via the liquid tube 220. The liquid pump 140 can thus pump the liquid through the liquid tube 220 around the sensor 110, into the liquid reservoir 225, and out from the liquid reservoir 225 to an inlet of the liquid pump 140. The liquid reservoir 225 can be disposed in the sensor housing 200. Alternatively, the liquid reservoir 225 can be disposed in another part of the vehicle 101, e.g., under a front hood, in a rear trunk, etc. The vehicle 101 can include more than one liquid reservoir 225 connected to the liquid tube 220.

The sensor housing 200 includes an air tube 230. The air tube 230 connects the air pump 145 to the sensor manifold 205. The air tube 230 allows air to move from the air pump 145 to the sensor 110 through the nozzles 210. The air tube 230 can be constructed of, e.g., a polymer, a metal, etc.

The sensor housing 200 includes a mixing valve 235. The mixing valve 235 can have an air inlet 240 connected to the air tube 230 and a liquid inlet 245 connected to a mixing tube 250, described below. The mixing valve 235 has an outlet 255 connected to the sensor manifold 205. The mixing valve 235 allows air and liquid to move from the air tube 230 and the mixing tube 235, respectively, into the sensor manifold 205 and to the nozzle 210. When the computer 105 determines to clean the sensor 110, the computer 105 actuates a diverter valve 265 to allow the liquid to move through a mixing tube 250, mixing the liquid and the air in the mixing vale 235 into an air-liquid mixture and allowing the air-liquid mixture to move through the openings 215 in the nozzles 210 and onto the sensor 110.

The sensor manifold 205 includes a fluid passage 260. The fluid passage 260 connects the mixing valve 235 to the nozzles 210. The fluid passage 260 allows the air or the air-liquid mixture to move from the mixing valve 235 to the nozzles 210. The fluid passage 260 can be, e.g., a cavity formed in the sensor manifold 205 as shown in FIGS. 4-7, a set of tubes connecting the mixing valve 235 to each of the nozzles 210, etc.

The sensor housing 200 includes a diverter valve 265. The diverter valve 265 is connected to the liquid tube 220 and the mixing tube 250. The diverter valve 235 includes a liquid outlet 270 and a mixing outlet 275. The liquid outlet 270 allows the liquid to move through the liquid tube 220 to the sensor 110. The mixing outlet 275 is connected to the mixing tube 250. The mixing tube 250 is connected to the mixing valve 235. The diverter valve 265 can be actuated by the computer 105 to selectively open the liquid outlet 270 and/or the mixing outlet 275 to allow the liquid to move through the liquid tube 220 and/or to allow the fluid to move through the mixing tube 250 and into the mixing valve 235. As described below, the computer 105 can actuate the diverter valve 265 to open and/or close the liquid outlet 270 and/or the mixing outlet 275.

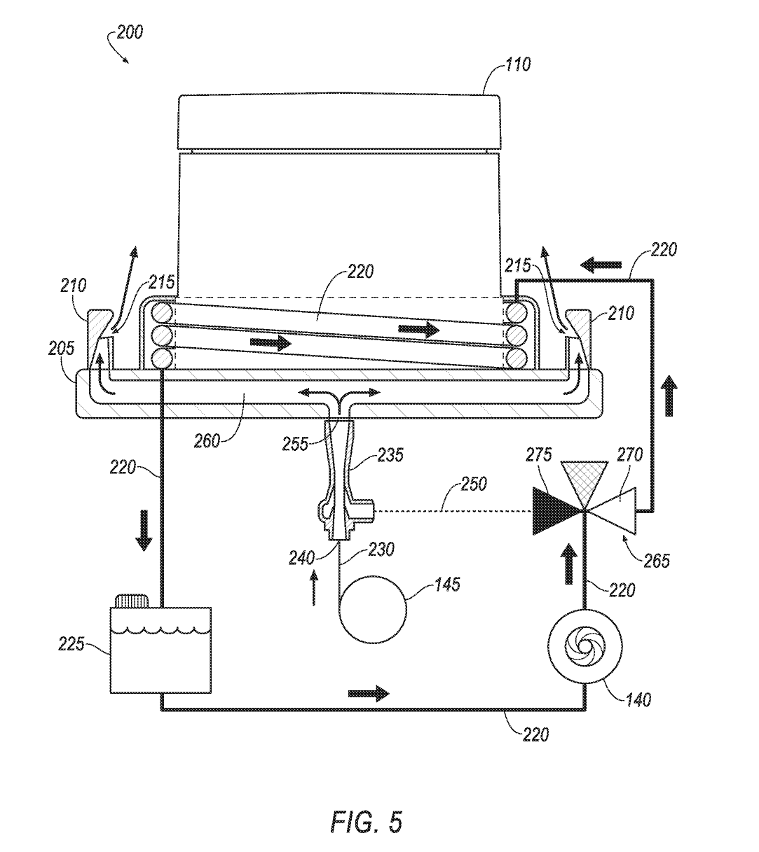

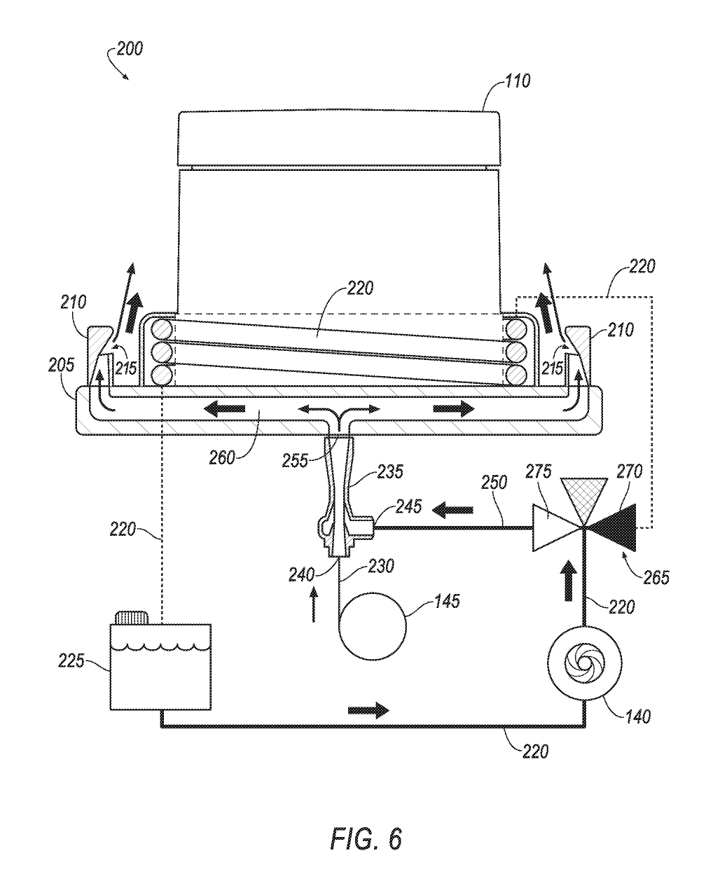

As illustrated, the liquid outlet 270 and the mixing outlet 275 are closed when the respective portion of the FIGS. 5-7 is solidly shaded, and the liquid outlet 270 and the mixing outlet 275 when the respective portion of the Figures is unshaded. For example, in FIG. 5, the mixing outlet 275 is closed (solidly shaded), and the liquid outlet 270 is open (not shaded). Furthermore, when one of the liquid tube 220 or the mixing tube 250 has no liquid flowing through, the respective tube 220, 250 is represented as a dashed line; in FIG. 5, the mixing tube 250 has no liquid flow, and is represented with a dashed line. Because liquid moves in the liquid tube 220, the liquid tube 220 is shown with a solid line. The flow of liquid is shown in thick arrows, and the flow of air is shown in thin arrows. For example, in FIG. 5, liquid (shown in thick arrows) flows only in the liquid tube 220 and air (shown in thin arrows) flows only in the fluid passage 260. In another example, in FIG. 6, both liquid and air flow through the fluid passage 260 and through the nozzles 210, shown as both thin arrows (representing air) and thick arrows (representing liquid) in the fluid passage 260 and the nozzles 210.

FIG. 5 illustrates an example actuation of the diverter valve 265. In the example of FIG. 5, the computer 105 instructs the diverter valve 265 to open the liquid outlet 270 and to close the mixing outlet 275. The liquid pump 140 pumps the liquid through the liquid tube 220 around the sensor 110, and the air pump 145 pumps air through the fluid passage 260 and the nozzles 210 onto the sensor 110. The diverter valve 265 prevents liquid from moving to the mixing tube 250 and through the fluid passage and the nozzles and onto the sensor 110. The computer 105 can actuate the diverter valve 265 in the manner shown in FIG. 5 when, e.g., the computer 105 determines to cool the sensor 110 but not to clean the sensor 110 and the liquid is not necessary to clean the sensor 110.

FIG. 6 illustrates another example actuation of the diverter valve 265. In the example of FIG. 6, the computer 105 instructs the diverter valve 265 to close the liquid outlet 270 and to open the mixing outlet 275. The liquid pump 140 pumps the liquid through the diverter valve 265 and the mixing tube 250 into the mixing valve 235. The mixing valve 235 allows the air from the air pump 145 and the liquid from the liquid pump 140 to mix and to move through the fluid passage 260. The air and liquid mixture then moves through the nozzles 210 through the openings 215 and onto the sensor 110. The computer 105 can actuate the diverter valve 265 in the manner shown in FIG. 6 when, e.g., the computer 105 determines to clean the sensor 110 but not to cool the sensor 110 and the liquid is not necessary to cool the sensor 110.

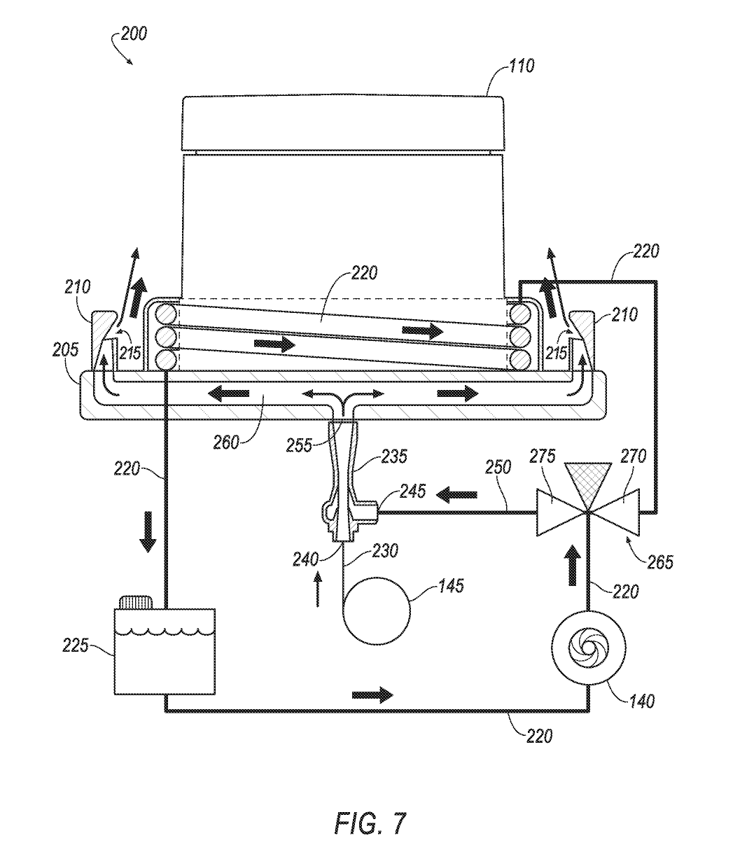

FIG. 7 illustrates another example actuation of the diverter valve 265. In the example of FIG. 7, the computer 105 instructs the diverter valve 265 to open the liquid outlet 270 and to open the mixing outlet 275. The liquid pump 140 pumps the liquid through the diverter valve 265, and the liquid moves through both the liquid tube 220 and the mixing tube 250. The liquid moving through the liquid tube 220 cools the sensor 110, and the liquid moving through the mixing tube 250 is mixed with the air in the mixing valve 235 and moves through the fluid passage 260 and the nozzles 210 though the openings 215 onto the sensor 110. The computer 105 can actuate the diverter valve 265 in the manner shown in FIG. 7 when, e.g., the computer 105 determines to both clean and cool the sensor 110.

The computer 105 can determine an amount of occluding material on the sensor 110. The computer 105 can actuate the sensor 110 to collect data 115 and determine the amount of occluding material on the sensor 110 from the collected data 115. For example, the computer 105 can apply a conventional blur detection technique to the data 115 to determine if an image from the data 115 is blurred. The computer 105 can measure a pixel-to-pixel contrast of the image from the data 115 and determine a blurred pixel when the pixel, when convolved with a predetermined Laplacian kernel, has a statistical variance σ² (i.e., the square of the standard deviation σ as used in statistical analysis) greater than a predetermined threshold. Alternatively, the computer 105 can use a different blur detection technique to determine a number of blurred pixels. The computer 105 can determine the amount of occluding material as a fraction of the number of blurred pixels (determined based on a blur detection technique such as described above) to the total number of pixels in the image from the data 115.

As another example, the computer 105 can use a conventional light attenuation technique on the image from the data 115 to determine an amount of occluding material on the sensor 110. The computer 105 can detect an attenuation of incoming light, i.e., an amount of light lost when traveling through the occluding material to the sensor 110, and a scattering of stray light towards the sensor 110 by the occluding material on the sensor 110. The computer can apply conventional natural image statistics techniques (e.g., Bayesian de-noising) to the image to determine pixels where a scene radiance is reduced by the occluding material and pixels where the occluding material contributes radiance to the sensor 110 by scattering the light from another direction. The computer 105 can determine a number of pixels in the image from the data 115 where the attenuation of the light is reduced, and the computer 105 can determine the amount of occluding material as a fraction of the number of pixels with reduced attenuation to the total number of pixels in the image from the data 115.

The computer 105 can use a conventional image comparison technique to determine the amount of occluding material on the sensor 110. The computer 105 can compare the image from the data 115 to an estimated background image based on, e.g., data 115 from another sensor 110, data 115 from the server 130, etc. The computer 105 can determine a number of pixels that differ from the estimated background image, i.e., the pixel “differs” from the estimated background image when a difference between the red-green-blue (RGB) or grayscale values of the pixel from the image from the data 115 and the RGB or grayscale values of the corresponding pixel from the estimated background image is greater than a difference threshold. The difference threshold can be a predetermined value stored in the data store 106 and determined by, e.g., empirical testing, known statistical standards, etc. The computer 105 can determine the amount of occluding material as a fraction of the number of pixels that differ from the estimated background image to the total number of pixels in the image from the data 115.

The computer 105 can use a conventional stereovision image comparison technique to determine the amount of occluding material on the sensor 110. The sensor 110 can be a stereovision image sensor 110, i.e., the sensor 110 can have two lenses separated by a fixed distance and captures two images simultaneously when collecting data 115. The computer 105 can compare the two simultaneously collected images and determine a number of pixels that differ between the two images, e.g., as described above for the image comparison technique. The computer 105 can determine the amount of occluding material as a fraction of the number of pixels that differ between the two images to the total number of pixels in the one of the images from the data 115.

Based on one or more of the above-described techniques, the computer 105 can determine the amount of occluding material on the sensor 110. A measurement of an amount of occluding material can be provided as a number between and including 0 and 1, representing a fraction of a number of pixels in an image collected by the sensor 110 that are obstructed by the occluding material. When the amount of occluding material is 0, the sensor 110 collects data 115 with no pixels obstructed by occluding material. When the amount of occluding material is 1, all of the pixels in the data 115 are obstructed by occluding material. The techniques described above illustrate one of a plurality of techniques for identifying pixels that are obstructed by occluding material, and upon identifying the pixels that are obstructed, the computer 105 can determine a fraction of the obstructed pixels to the total number of pixels, resulting in a number between 0 and 1, inclusive. That number is one example of the amount of occluding material on the sensor 110.

The computer 105 can determine a temperature of the sensor 110. The sensor 110 can include a temperature sensor 110 (e.g., a thermocouple, a thermistor, etc.) that can collect data 115 about the temperature of the sensor 110. The temperature sensor 110, while not shown in the Figures, can be fixed to the sensor 110 in the sensor housing 200. The computer 105 can, based on the temperature data 115, actuate the liquid pump 140, the air pump 145, and the diverter valve 265.

The computer 105 can compare the amount of occluding material to an occluding material threshold. The occluding material threshold can be a predetermined value, e.g., between and including 0 and 1, stored in the data store 106 and/or the server 130. The occluding material threshold can be based on an amount of occluding material beyond which the sensor 110 operation is reduced more than the reduction of sensor 110 operation based on the temperature threshold (described below). For example, the occluding material threshold can be a fraction of a total number of pixels from an image from collected data 115 from the sensor 110 beyond which the computer 105 determines that the sensor 110 is no longer collecting enough data 115 (i.e., enough pixels are obstructed) to operate the components 120. The occluding material threshold can be determined based on, e.g., empirical tests of sensor 110 operation, manufacturer specifications, etc. The occluding material threshold can be, e.g., 0.7, i.e., 70% of the pixels in an image from the data 115 are obstructed by occluding material.

The computer 105 can compare the temperature to a temperature threshold. The temperature threshold can be a predetermined value stored in the data store 106 and/or the server 130. The temperature threshold can be based on a temperature beyond which operation of the sensor can be reduced, e.g., 105° C. The temperature threshold can be determined based on, e.g., empirical tests of sensor 110 operation, manufacturer specifications, etc.

Based on an amount of occluding material and the temperature, the computer 105 can the computer 105 can actuate the liquid pump 140 and the air pump 145 to specified respective duty cycles. For example, the computer 105 can actuate the liquid pump 140 and the air pump 145 in one of four modes based on the temperature threshold and the occluding matter threshold. Each of the four modes specifies a liquid pump 140 duty cycle for the liquid pump 140 and an air pump 145 duty cycle for the air pump 145.

The computer 105 can actuate the diverter valve, the liquid pump 140, and the air pump 145 in a first mode when the amount of occluding matter on the sensor 110 is below the occluding matter threshold (as described above) and the temperature of the sensor 110 is below the temperature threshold (as described above). In the first mode, the computer 105 determines not to immediately clean or cool the sensor 110, and can operate the diverter valve 265 such that the liquid outlet 270 is open and the mixing outlet 275 is closed, e.g., as shown in FIG. 5. The computer 105 can determine to clean the sensor 110 and can open the mixing outlet 275 to allow liquid to mix with the air and spray through the nozzles 210 onto the sensor 110, e.g., as shown in FIG. 7. When the computer 105 determines to stop cleaning the sensor 110, the computer 105 can instruct the mixing outlet 275 to close. The computer 105 can specify a first liquid pump 140 duty cycle and a first air pump 145 duty cycle to allow cleaning the sensor 110 upon request by the vehicle 101 user.

The computer 105 can actuate the diverter valve 265, the liquid pump 140, and the air pump 145 in a second mode when the amount of occluding matter on the sensor 110 is below the occluding matter threshold and the temperature of the sensor 110 is above the temperature threshold. In the second mode, the computer 105 can determine that cooling the sensor 110 has priority over cleaning the sensor 110. The computer 105 can close the mixing outlet 275, open the liquid outlet 270, and increase the duty cycle of the liquid pump 140 to a second liquid pump 140 duty cycle to increase cooling of the sensor 110 with liquid convection cooling, as shown in FIG. 5. The computer 105 can actuate the air pump 145 to a second air pump 145 duty cycle to increase air flow further cool the sensor 110 with air convection cooling. If the computer 105 receives a request to clean the sensor 110 from the vehicle 101 user, the computer 105 can open the mixing outlet 275 to allow liquid to mix with the air and spray through the nozzles onto the sensor 110, e.g., as shown in FIG. 7. When the computer 105 no longer receives the request, the computer 105 can instruct the mixing outlet 275 to close. That is, the second liquid pump 140 duty cycle is greater than the first liquid pump 140 duty cycle to accommodate the increased liquid flow for cleaning of the sensor 110 upon request by the vehicle 101 user and for cooling the sensor 110. The computer 105 can deactivate the sensor 110 upon determining that the temperature of the sensor 110 is above the temperature threshold.

The computer 105 can actuate the diverter valve 265, the liquid pump 140, and the air pump 145 in a third mode when the amount of occluding matter on the sensor 110 is above the occluding matter threshold and the temperature of the sensor 110 is above the temperature threshold. In the third mode, the computer 105 can determine to both clean and cool the sensor 110 and that both cooling and cleaning the sensor 110 should not be performed simultaneously. The computer 105 can deactivate the sensor 110 and actuate one or more vehicle components 120 to move the vehicle 101 away from a roadway (e.g., to a roadway shoulder) and stop the vehicle 101. The computer 105 can then actuate the liquid pump 140 to a third liquid pump 140 duty cycle and the air pump 145 to a third air pump 145 duty cycle. The computer 105 can actuate the diverter valve 265 to close the mixing outlet 275 and open the liquid outlet 270, allowing the liquid to move through the liquid tube 220 and cool the sensor 110, as shown in FIG. 5. When the computer 105 determines that the temperature of the sensor 110 is below the temperature threshold, the computer 105 can actuate the diverter valve 265 to open the mixing outlet 275 and close the liquid outlet 270, allowing the liquid to move through the mixing tube 250 to mix with the air and spray onto the sensor 110, cleaning the sensor 110 as shown in FIG. 6. When the computer 105 determines that the amount of occluding material on the sensor 110 is below the occluding material threshold, the computer 105 can activate the sensor 110 and actuate one or more vehicle components 120 to move the vehicle 101.

The computer 105 can actuate the diverter valve 265, the liquid pump 140, and the air pump 145 in a fourth mode when the amount of occluding matter on the sensor 110 is above the occluding matter threshold and the temperature of the sensor 110 is below the temperature threshold. In the fourth mode, the computer 105 can determine that cleaning the sensor 110 has priority over cooling the sensor 110. The computer 105 can actuate the liquid pump 140 to a fourth liquid pump 140 duty cycle and the air pump 145 to a fourth air pump 145 duty cycle. The computer 105 can actuate the diverter valve 265 to open the mixing outlet 275 and to close the liquid outlet 270, as shown in FIG. 6, to clean the sensor 110.

Rules governing actuation of the diverter valve 265, liquid pump 140, and the air pump 145 can be included as a look-up table stored in the data store 106 and/or the server 130 accessible by the computer 105 via the network 125. An example table is shown below in Table 1.

TABLE 1

| | Liquid Pump | Air Pump | | |
|---|---|---|---|---|
| Mode | Duty Cycle | Duty Cycle | Liquid Outlet | Mixing Outlet |
| 1^{st} | 30% | 30% | Open | Closed |
| 2^{nd} | 60% | 50% | Open | Closed |
| 3^{rd}-above | 90% | 70% | Open | Closed |
| temperature | | | | |
| threshold | | | | |
| 3^{rd}-below | 90% | 90% | Closed | Open |
| temperature | | | | |
| threshold | | | | |
| 4^{th} | 60% | 50% | Closed | Open |

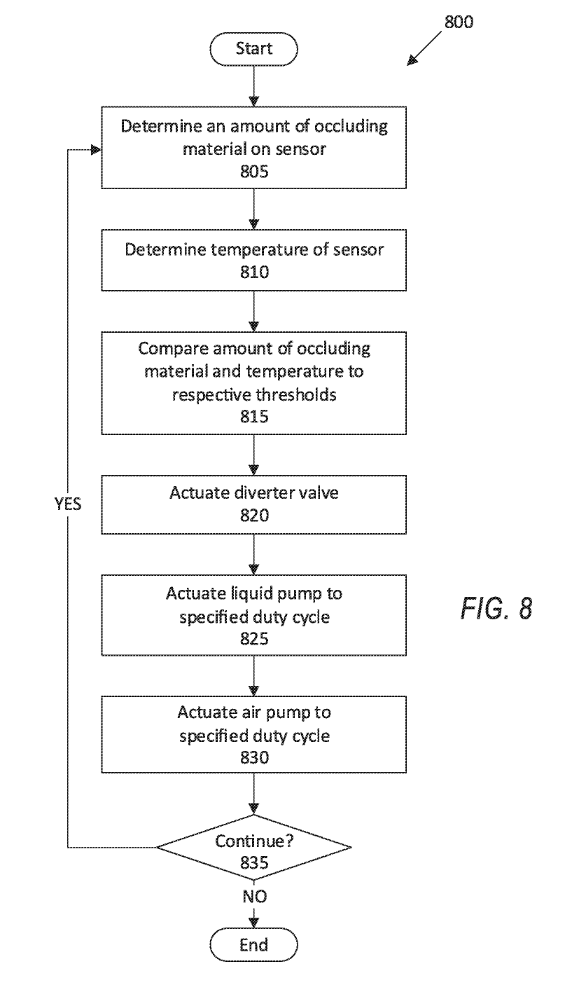

FIG. 8 illustrates an example process 800 for cleaning and cooling a sensor 110 in a vehicle 101. The process 800 begins in a block 805, in which the computer 105 determines an amount of occluding material on a sensor 110. As described above, the computer 105 can use a conventional image processing technique to determine a number of pixels in an image from the data 115 obstructed by occluding material to determine the amount of occluding material on the sensor 110.

Next, in a block 810, the computer 105 determines a temperature of the sensor 110. The sensor housing can include a temperature sensor 110 that can collect temperature data 115 from the sensor 110. The computer 105 can determine the temperature of the sensor 110 from the temperature data 115.

Next, in a block 815, the computer 105 compares the amount of occluding material to an occluding material threshold and the temperature to a temperature threshold. As described above, based on whether one or both of the amount of occluding material and the temperature exceeds their respective thresholds, the computer 105 can actuate components 120 in a specified manner to cool and clean the sensor 110.

Next, in a block 820, the computer 105 actuates the diverter valve 265 based on the amount of occluding material and the temperature. For example, when the amount of occluding material is above the occluding material threshold and the temperature is below the temperature threshold, the computer 105 can actuate the diverter valve 265 to open the mixing outlet 275 and to close the liquid outlet 270, as shown in FIG. 6, to clean the sensor 110.

Next, in a block 825, the computer 105 actuates the liquid pump 140 to a specified duty cycle. As described above, the computer 105 can determine the liquid pump 140 duty cycle based on the amount of occluding material and the temperature. For example, when the temperature is above the temperature threshold and the amount of occluding material is below the occluding material threshold, the computer 105 can actuate the liquid pump 140 to a liquid pump 140 duty cycle of 60%, as shown in Table 4 above.

Next, in a block 830, the computer 105 actuates the air pump 145 to a specified duty cycle. As described above, the computer 105 can determine the air pump 145 duty cycle based on the amount of occluding material and the temperature. For example, when the temperature is above the temperature threshold and the amount of occluding material is below the occluding material threshold the computer 105 can actuate the air pump 145 to an air pump 145 duty cycle of 50%, as shown in Table 4 above.

Next, in a block 835, the computer 105 determines whether to continue the process 800. For example, if the temperature of the sensor 110 falls below the temperature threshold, and the vehicle 101 is still moving to a destination, the computer 105 can determine to continue the process 800 to determine whether to clean the sensor 110. If the computer 105 determines to continue, the process 800 returns to the block 805 to determine an amount of occluding material on the sensor 110. Otherwise, the process 800 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computers 105 generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 800, one or more of the steps could be omitted, or the steps could be executed in a different order than shown in FIG. 8. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer including a processor and a memory, the memory storing instructions executable by the processor to:
determine an amount of occluding material on a vehicle sensor;
determine a temperature of the vehicle sensor; and
actuate a liquid pump arranged to pump liquid to the vehicle sensor and an air pump arranged to pump air to the vehicle sensor based on the amount of occluding material and the temperature.

2. The system of claim 1, wherein the instructions further include instructions to pump liquid through a liquid tube extending around the vehicle sensor.

3. The system of claim 1, wherein the instructions further include instructions to actuate a diverter valve to pump liquid and air through an opening in a sensor housing onto the vehicle sensor.

4. The system of claim 3, wherein the instructions further include instructions to actuate the diverter valve when the amount of occluding material exceeds an occluding material threshold.

5. The system of claim 1, wherein the instructions further include instructions to deactivate the sensor when the temperature exceeds a temperature threshold.

6. The system of claim 1, wherein the instructions further include instructions to actuate the liquid pump to a specified liquid pump duty cycle based on the amount of occluding material and the temperature.

7. The system of claim 1, wherein the instructions further include instructions to actuate the air pump to a specified air pump duty cycle based on the amount of occluding material and the temperature.

8. The system of claim 1, wherein the instructions further include instructions to, when the temperature is above a temperature threshold and the amount of occluding material is above an occluding material threshold, actuate the liquid pump and the air pump to cool the vehicle sensor.

9. The system of claim 8, wherein the instructions further include instructions to determine a second temperature of the vehicle sensor and, when the second temperature is below the temperature threshold, actuate a diverter valve to pump liquid and air through an opening in a sensor housing onto the vehicle sensor.

10. A system, comprising:
a sensor housing including a fluid opening;
a vehicle sensor disposed the sensor housing;
a liquid pump disposed in the sensor housing;
an air pump disposed in the sensor housing;
a liquid tube connected to the liquid pump extending around the vehicle sensor;
an air tube connected to the air pump and the fluid opening;
means for determining an amount of occluding material on the vehicle sensor;
means for determining a temperature of the vehicle sensor; and
means for actuating the liquid pump and the air pump based on the amount of occluding material and the temperature.

11. The system of claim 10, further comprising means for actuating a diverter valve to pump liquid and air through the fluid opening onto the vehicle sensor.

12. The system of claim 10, further comprising means for deactivating the sensor when the temperature exceeds a temperature threshold.

13. The system of claim 10, further comprising means for actuating the liquid pump and the air pump to cool the vehicle sensor when the temperature is above a temperature threshold and the amount of occluding material is above an occluding material threshold.

14. The system of claim 10, further comprising means for determining a second temperature of the vehicle sensor and means for actuating a diverter valve to pump liquid and air through an opening in a sensor housing onto the vehicle sensor when the second temperature is below a temperature threshold.

15. A method, comprising:
determining an amount of occluding material on a vehicle sensor;
determining a temperature of the vehicle sensor; and
actuating a liquid pump to pump liquid to the vehicle sensor and an air pump to pump air to the vehicle sensor based on the amount of occluding material and the temperature.

16. The method of claim 15, further comprising pumping liquid through a liquid tube extending around the vehicle sensor.

17. The method of claim 15, further comprising actuating a diverter valve to pump liquid and air through an opening in a sensor housing onto the vehicle sensor.

18. The method of claim 17, further comprising actuating the diverter valve when the amount of occluding material exceeds an occluding material threshold.

19. The method of claim 15, further comprising deactivating the sensor when the temperature exceeds a temperature threshold.

20. The method of claim 15, further comprising, when the temperature is above a temperature threshold and the amount of occluding material is above an occluding material threshold, actuating the liquid pump and the air pump to cool the vehicle sensor.
